(19) United States
(12) Patent Application Publication
(10) Pub. No.: US 2011/0036764 A1
(43) Pub. Date: Feb. 17, 2011

(54) REPLACEABLE HOLLOW FIBER MEMBRANE FILTER DEVICE

(76) Inventor: Yen-Liang LIN, Taipei County (TW)

Correspondence Address: Hershkovitz & Associates, LLC, 2845 Duke Street, Alexandria, VA, 22314, US

(21) Appl. No.: 12/833,972

(22) Filed: Jul. 10, 2010

(30) Foreign Application Priority Data
Aug. 11, 2009 (CN) 200920234865.9

(51) Int. Cl. B01D 63/02; B01D 63/04

(52) U.S. Cl. 210/232; 210/321.89

(57) ABSTRACT

A replaceable hollow fiber membrane filter device comprising an upper cap, a lower cap, and a cartridge. The cartridge has multiple hollow fiber membrane bundles inside, and an upper and a lower membrane tube covers which are used to fix two ends of hollow fiber membrane bundles. The bottom of each hollow fiber membrane bundle has a lower membrane lagging; the top of each hollow fiber membrane bundle has an upper membrane lagging which extends outward to make a flow way; on the lower membrane tube cover there has multiple slots which conjugate with the fringe of the lower membrane lagging, and on the upper membrane tube cover there has multiple sockets which conjugate with the fringe of the upper membrane lagging, and both are seal-connected by a disassembling structure. The upper end and the lower end of each hollow fiber membrane bundle respectively goes through the upper and the lower membrane lagging, and is mounted inside the upper and the lower membrane tube cover, and seal-connected by disassembling structure. Therefore, the present invention may provide a method of replacement or cleaning single hollow fiber membrane bundle instead of replacing whole filter device, so the cost is down.

### TECHNICAL FIELD OF THE INVENTION

The prevent invention is related to a replaceable hollow fiber membrane filter device, especially related to a device used to manage water filtration for water purification management business.

### BACKGROUND ART

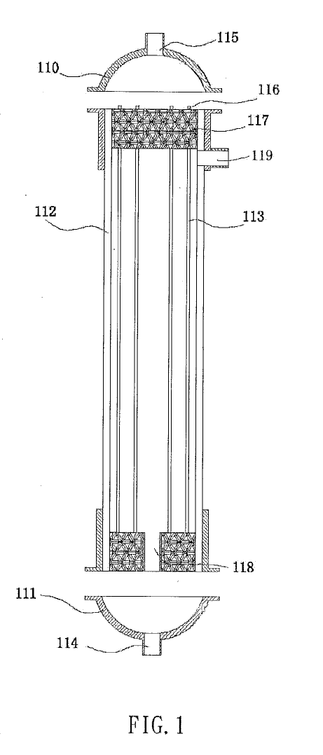

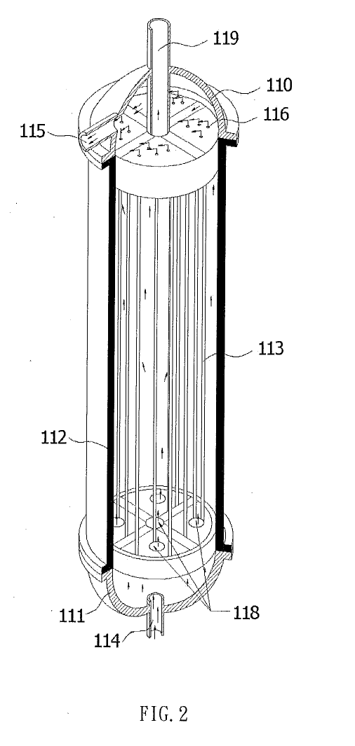

Hollow fiber membrane is broadly used in the field of pressurized water filtration, purification management, and even used in the condition of going chemical processing and biochemical processing. The major structure of hollow fiber membrane is as follow. In a perpendicular style (or laying style) of a cartridge hull (pressurized container) there is mounted a hollow fiber bundle. As showing in FIG. 1 and FIG. 2, the cartridge hull comprises an upper cap(110), a lower cap(111), and a cartridge(112). Inside the said cartridge(112) there is multiple hollow fiber membrane tube(113); from two ends, each tube is fixed to inner wall of cartridge(112) by sealing agent(117) and forms a bundle. The said upper cap(110) has water outlet(115), and the said lower cap(111) has water inlet(114); the hollow fiber membrane tube(113) near the water inlet(114) side is sealed by sealing agent(117), and the other side (near the water outlet) extends outward to form a flow way(116). From water inlet(114), the raw water flows into cartridge(112) through inlet way(118), under a determined pressure the water permeates into the tube through the micro holes which are located in periphery of the wall of hollow fiber membrane tube(113). Then the purified water (the filtrated water) of each hollow fiber membrane tube(113) flows out from water outlet(115) through the flow way(116); the residual sewage is remaindered in the space between cartridge(112) and hollow fiber membrane tube(113). To avoid militating the quality of water purification, the sewage is discharged from sewage outlet(119) which is located in one side of cartridge(112).

As described above, two ends of hollow fiber membrane tube bundle is sealed and fixed to inner side of the cartridge by sealing agent (to ensure the stretching state of hollow fiber membrane tube), therefore if the fiber membrane tube is contaminated or damaged, there is no way to withdraw for cleaning up or for replacement. That means wastage because it is necessary to replace whole cartridge hull, so the cost is increased.

### SUMMARY OF THE INVENTION

The object of present invention is to provide a replaceable hollow fiber membrane filter device which has an easily replaceable and cleanable hollow fiber membrane bundle. By using this device, the average water outlet rate of purified water is enhanced; the duration of the usage of hollow fiber membrane bundle is prolonged. Moreover, separate replacement of hollow fiber membrane bundle may decrease the cost.

To achieve the above objects, the inventor of present invention introduces a technical scheme described below. It is a replaceable hollow fiber membrane filter device comprising an upper cap and a lower cap, and a cartridge. The upper cap has water outlet and the lower cap has water inlet; the upper cap and the lower cap is located at each end of the cartridge separately. There are multiple hollow fiber membrane bundle located in the cartridge, and installed inside of the upper cap and lower cap through upper and lower membrane tube cover. A holder connects and supports upper and lower membrane tube cover to maintain the hollow fiber membrane bundle in stretching state. The said lower membrane tube cover has multiple slots on it. At the bottom of each hollow fiber membrane bundle has lower membrane lagging which inserts in corresponding slot. The upper membrane tube cover has socket which corresponds the position of each slot. At the top of each hollow fiber membrane bundle has upper membrane lagging which inserts in the said socket, and upper membrane lagging and socket can be sealed and connected by a disassembling structure. The top of hollow fiber membrane bundle extends to outside of the upper membrane lagging and forms a flow way.

During the time of using present invention, raw water (water wait to be filtered) enters into cartridge from the water inlet of lower cap; by the effect of a determined positive or negative pressure, the water permeates into the tube through the micro holes located in periphery of the wall of hollow fiber membrane tube, then through flow way flows out from water outlet of upper cap (the flow out water is the filtrated water). If the hollow fiber membrane bundle needs to be cleaned up, open the upper cap, from the cartridge withdraw the upper membrane tube cover as well as hollow fiber membrane bundle and lower membrane tube cover which is connected by a holder. Then it is possible to rinse the hollow fiber membrane bundle; or replace the hollow fiber membrane bundle at the time of replacement; then put the renewed one back to the cartridge without changing whole set of upper and lower membrane tube cover.

In the above technical scheme, each hollow fiber membrane bundle is composed of one or plural hollow fiber membrane filament(s), and steadily connected with the upper and the lower membrane lagging by sealing agent.

By using the above technical scheme, the present invention possesses some advantages comparing with the existent technique:

1. According to the present invention, two ends of each hollow fiber membrane bundle is located at upper and lower membrane lagging respectively, and seal-connected to socket by a disassembling structure. If only few of hollow fiber membrane bundle are choked, it is possible to withdraw these parts and just replace them, no necessary to replace whole set of upper and lower membrane cover, and all of the hollow fiber membrane bundles. Thus the cost is down.

2. The upper and the lower membrane laggings are seal-connected to hollow fiber membrane bundles by sealing agent. Therefore it is handily to manufacture a hollow fiber membrane bundle through using multiple fiber membrane filaments or single fiber membrane tube. The application can be wide.

### SELECTED REPRESENTATIVE DRAWING

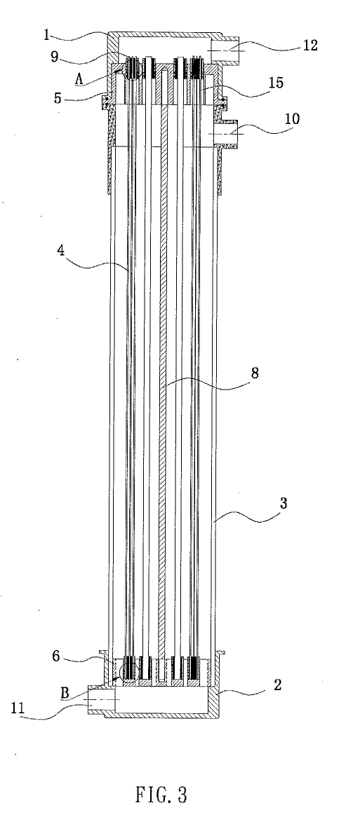

1. The selected representative drawing in this invention is FIG. 3.

2. Brief description of the elements presenting in FIG. 3

| | | | |
|---|---|---|---|
| 1 | upper cap | 2 | lower cap |
| 3 | cartridge | 4 | hollow fiber membrane bundle |
| 5 | upper membrane tube cover | | |
| 6 | lower membrane tube cover | | |
| 8 | holder | 9 | flow way |
| 10 | sewage outlet | 11 | water inlet |
| 12 | water outlet | 15 | socket |

### BRIEF DESCRIPTION OF THE DRAWINGS

FIG. 1 is a diagram demonstrating the structure of the existent technique;

FIG. 2 is another diagram demonstrating the structure of the existent technique;

FIG. 3 is a diagram demonstrating the structure of the first embodiment according to the present invention;

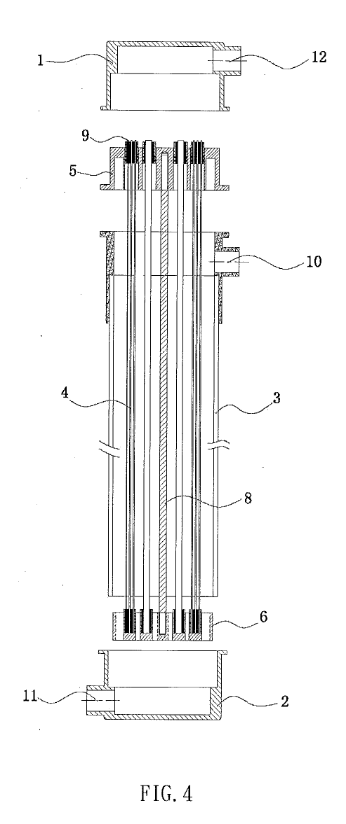

FIG. 4 is a diagram demonstrating disassembled view of FIG. 3;

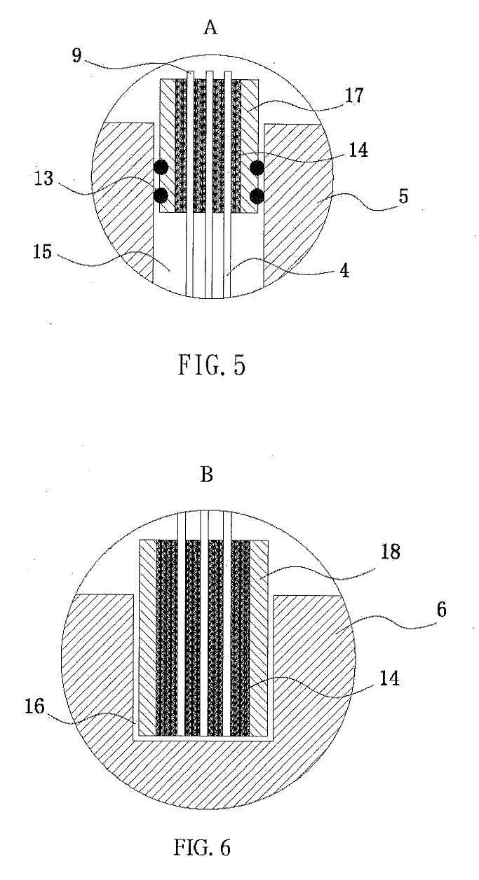

FIG. 5 is an enlargement diagram illustrating “A” of FIG. 3;

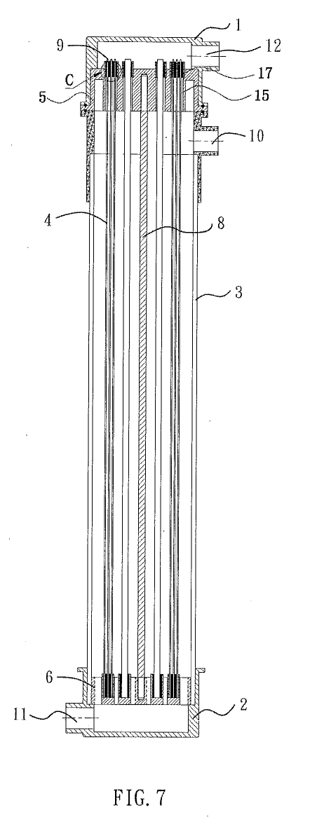

FIG. 6 is an enlargement diagram illustrating “B” of FIG. 3;

FIG. 7 is a diagram demonstrating another structure of the first embodiment according to the present invention;

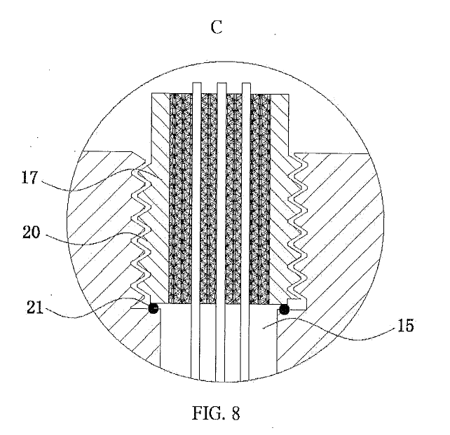

FIG. 8 is an enlargement diagram illustrating “C” of FIG. 7;

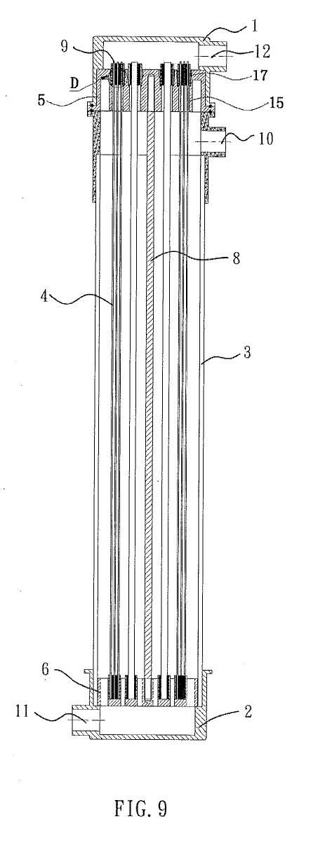

FIG. 9 is a diagram demonstrating another structure of the first embodiment according to the present invention;

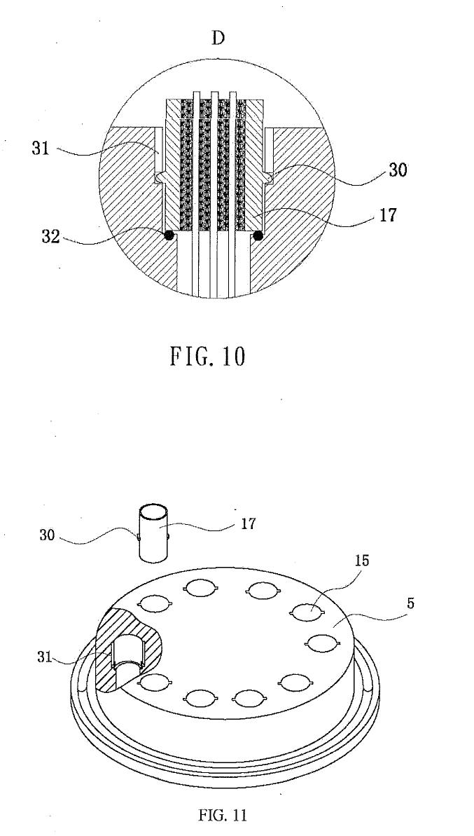

FIG. 10 is an enlargement diagram illustrating “D” of FIG. 9;

FIG. 11 is a disassembled view of upper membrane tube cover and upper membrane lagging according to FIG. 9;

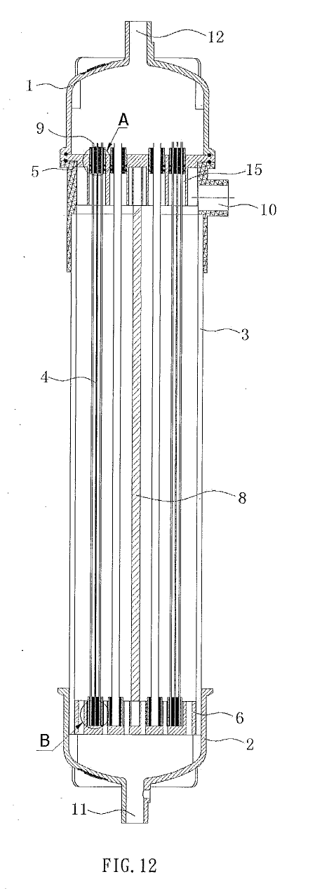

FIG. 12 is a diagram demonstrating a modified structure of upper cap, upper membrane tube cover, and lower cap according to FIG. 3;

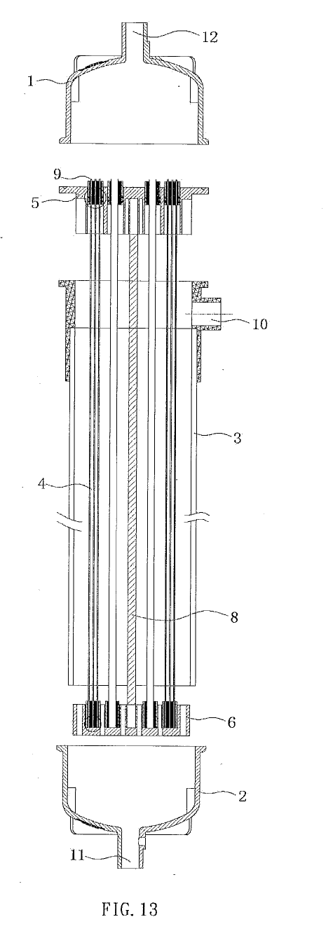

FIG. 13 is a disassembled view of FIG. 12;

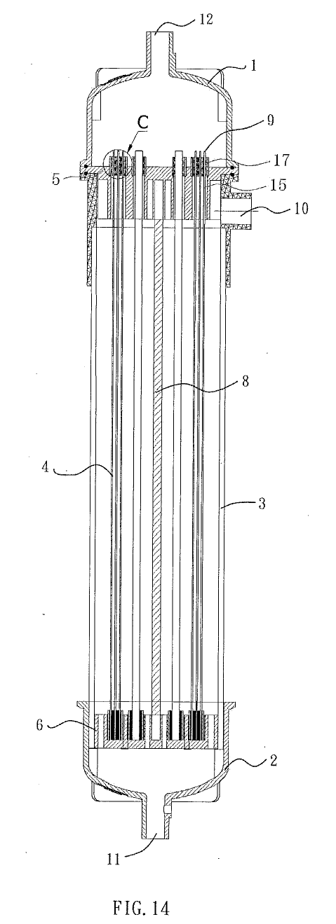

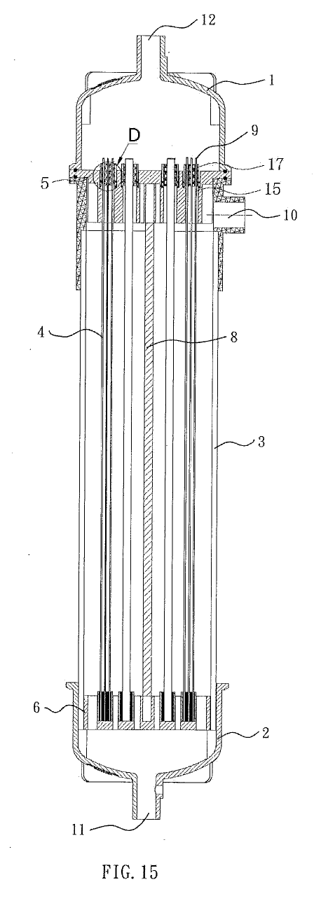

FIG. 14 is a diagram demonstrating another modified structure of upper cap, upper membrane tube cover, and lower cap according to FIG. 7;

FIG. 15 is a diagram demonstrating another modified structure of upper cap, upper membrane tube cover, and lower cap according to FIG. 9;

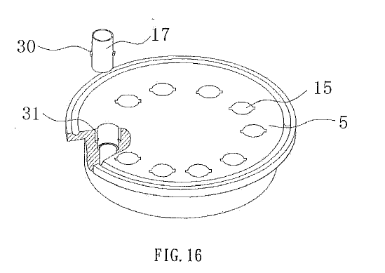

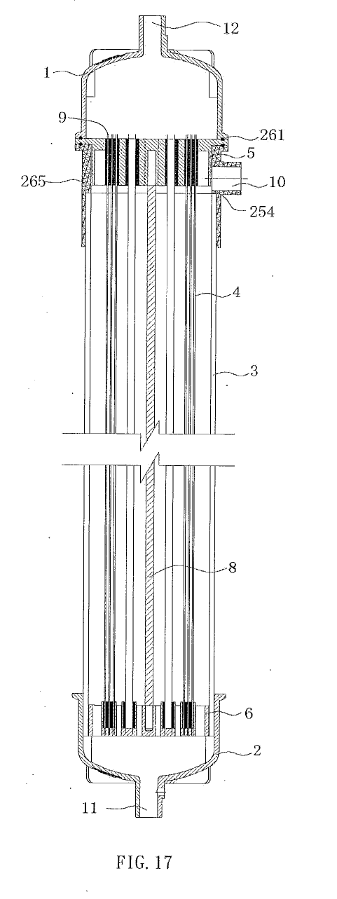

FIG. 16 is a disassembled view of upper membrane tube cover and upper membrane lagging according to FIG. 15;

FIG. 17 is a diagram demonstrating the structure of the second embodiment according to the present invention;

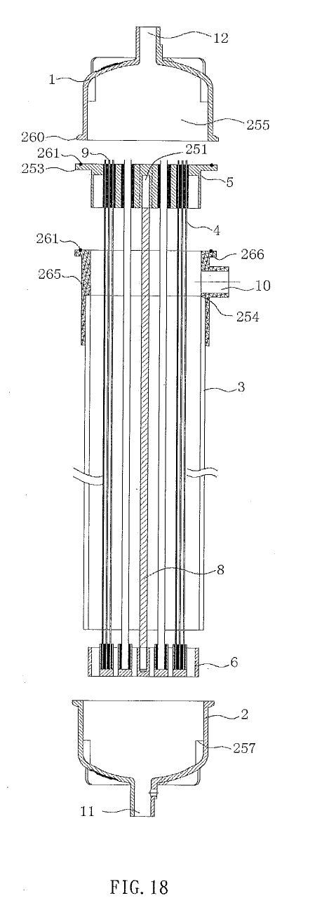

FIG. 18 is a disassembled view of dissection according to FIG. 17;

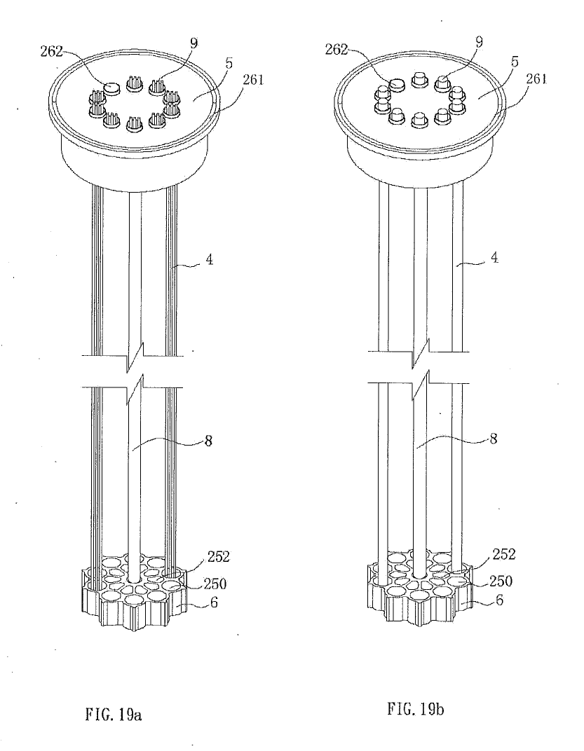

FIG. 19a is a diagram demonstrating the fixation mode by using hollow fiber membrane filament according to FIG. 18;

FIG. 19b is a diagram demonstrating the fixation mode by using hollow fiber membrane tube according to FIG. 18;

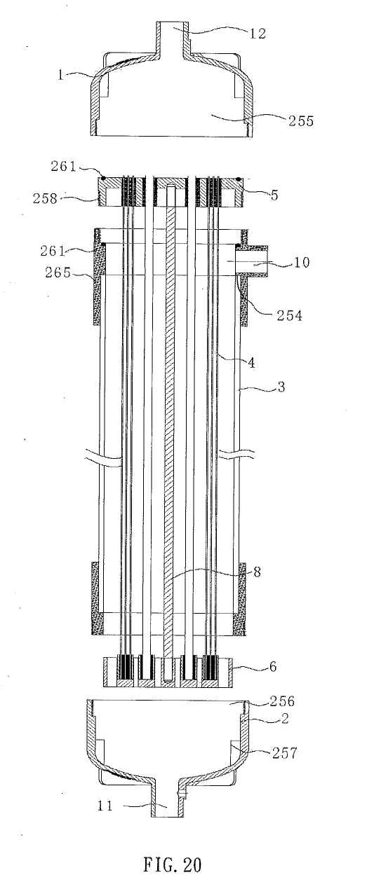

FIG. 20 is another disassembled view of dissection of the second embodiment according to the present invention;

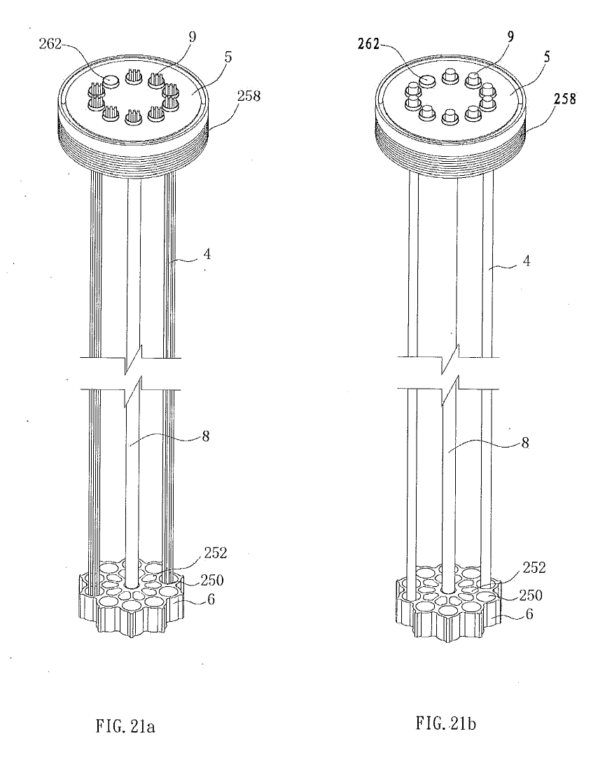

FIG. 21a is a diagram demonstrating the fixation mode by using hollow fiber membrane filament according to FIG. 20;

FIG. 21b is a diagram demonstrating the fixation mode by using hollow fiber membrane tube according to FIG. 20;

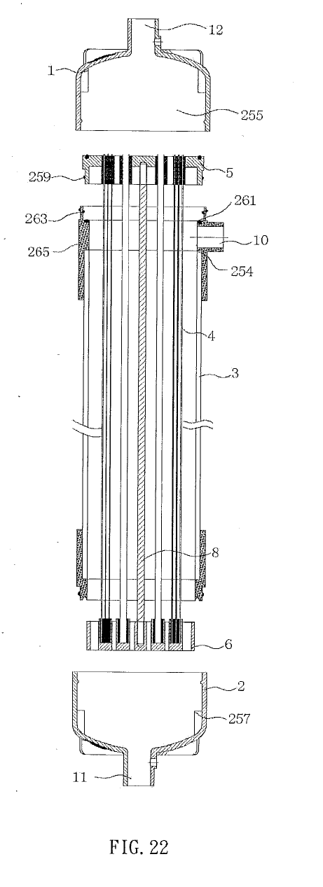

FIG. 22 is another disassembled view of dissection of the second embodiment according to the present invention;

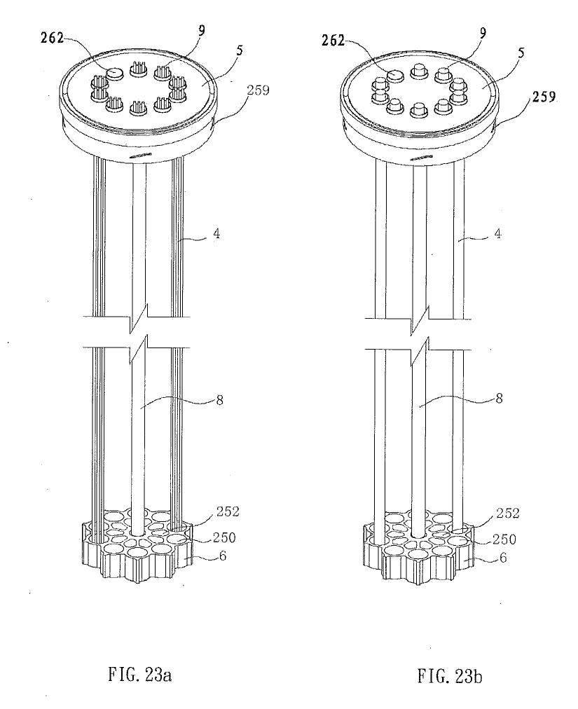

FIG. 23a is a diagram demonstrating the fixation mode by using hollow fiber membrane filament according to FIG. 22;

FIG. 23b is a diagram demonstrating the fixation mode by using hollow fiber membrane tube according to FIG. 22;

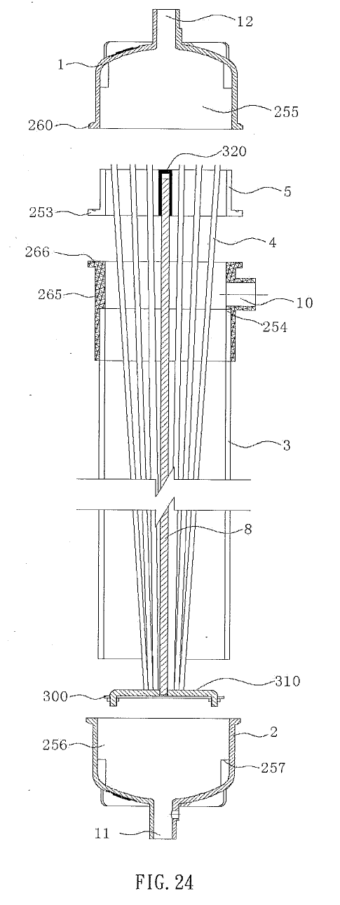

FIG. 24 is a disassembled view of dissection of the third embodiment according to the present invention;

FIG. 25 is a disassembled view of the structure of lower connecting tube according to FIG. 24;

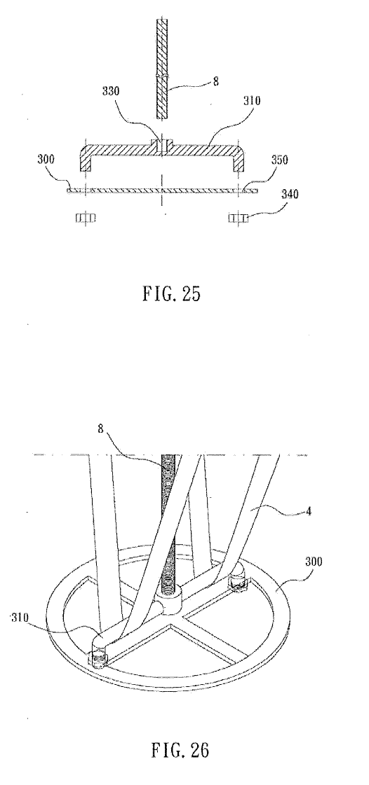

FIG. 26 is a diagram illustrating the mode of lower connecting tube during using according to FIG. 25;

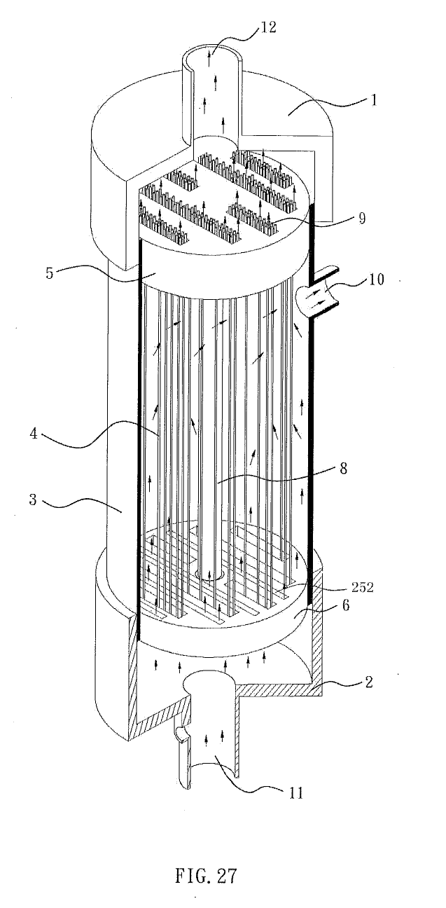

FIG. 27 is a tridimensional diagram illustrating the first mode of various arrangement of hollow fiber membrane bundle in upper, lower membrane tube during using;

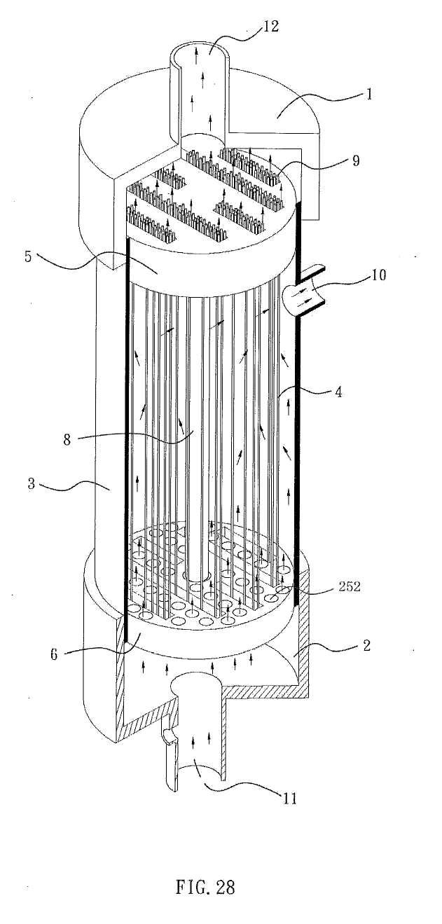

FIG. 28 is a tridimensional diagram illustrating the second mode of various arrangement of hollow fiber membrane bundle in upper, lower membrane tube during using;

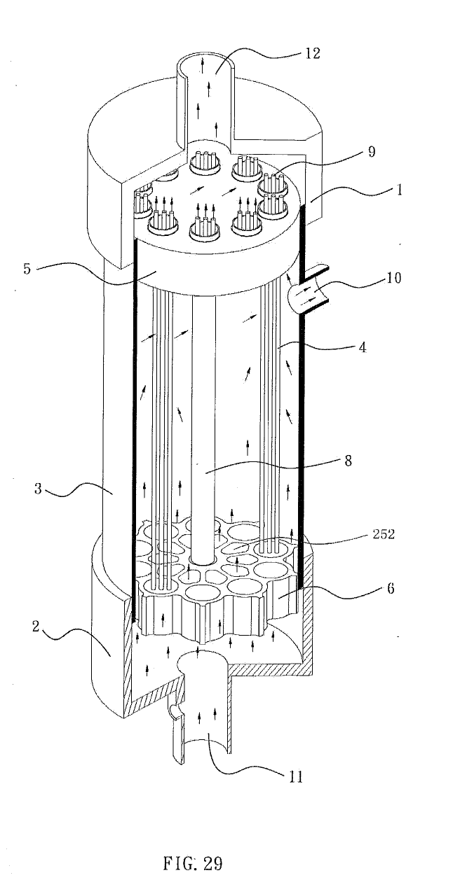

FIG. 29 is a tridimensional diagram illustrating the third mode of various arrangement of hollow fiber membrane bundle in upper, lower membrane tube during using;

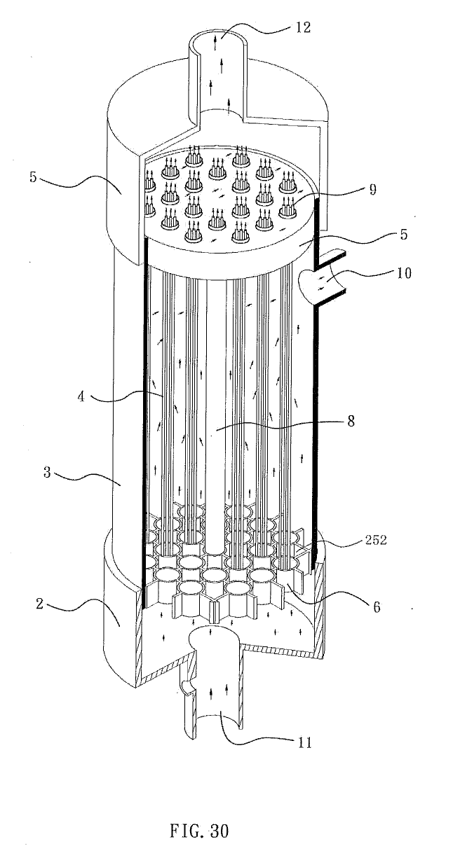

FIG. 30 is a tridimensional diagram illustrating the fourth mode of various arrangement of hollow fiber membrane bundle in upper, lower membrane tube during using.

### BRIEF DESCRIPTION OF THE ELEMENTS PRESENTING IN DRAWINGS

[existent technique]

| | | | |
|---|---|---|---|
| 110 | upper cap | 111 | lower cap |
| 112 | cartridge | 113 | hollow fiber membrane tube |
| 114 | water inlet | 115 | water outlet |
| 116 | flow way | 117 | sealing agent |
| 118 | water input way | 119 | sewage outlet |

[present invention]

| | | | |
|---|---|---|---|
| 1 | upper cap | 2 | lower cap |
| 3 | cartridge | 4 | hollow fiber membrane bundle |
| 5 | upper membrane tube | 6 | lower membrane tube cover |
| | cover | | |
| 8 | holder | 9 | flow way |
| 10 | sewage outlet | 11 | water inlet |
| 12 | water outlet | 13 | sealing ring |
| 14 | sealing agent | 15 | socket |
| 16 | slot | 17 | upper membrane lagging |
| 18 | lower membrane lagging | 20 | outer screw thread |
| 21 | sealing ring | 30 | protruding button |
| 31 | chute | 32 | sealing ring |
| 250 | fixing hole | 251 | fixing hole |
| 252 | water input way | 253 | flange |
| 254 | upper annulus stair | 255 | space of upper cap |
| 256 | space of lower cap | 257 | lower annulus stair |
| 258 | outer screw thread | 259 | locking protrusion |
| 260 | flange of upper cap | 261 | O-type sealing ring |
| 262 | penetrating hole | 263 | allocated protrusion |
| 265 | casing | 266 | flange |
| 300 | filament pressing disc | 310 | filament pressing rod |
| 320 | screwing hole | 330 | screwing hole |
| 340 | screw nut | 350 | fixing hole |

### DETAILED DESCRIPTION OF THE PREFERRED EMBODIMENTS

In order to explain the technique of the present invention clearly and completely, three replaceable hollow fiber membrane filter devices according to the present invention will now be described in reference to the drawings, like numerals referring to likes parts throughout the drawings.

### The First Embodiment

Referring now to FIG. 3 to FIG. 6, and FIG. 12, and FIG. 13, there is illustrating a replaceable hollow fiber membrane filter device according to the present invention, comprising an upper cap(1), a lower cap(2), and a cartridge(3). The cartridge has multiple hollow fiber membrane bundles(4) inside; and has an upper membrane tube cover(5) and a lower membrane tube cover(6) which are used to fix the hollow fiber membrane bundle(4) and two ends of a holder(8). At the bottom of each hollow fiber membrane bundle(4) there is provided a lower membrane lagging(18); at the top of each hollow fiber membrane bundle(4) there is provided an upper membrane lagging(17) which extends outward to form a flow way(9). The lower membrane tube cover(6) has slot(16) for conjugating with lower membrane lagging(18). The upper membrane tube cover(5) has multiple sockets for conjugating with the fringe of the upper membrane lagging(17); both are seal-connected by a disassembling structure.

Each hollow fiber membrane bundle(4) is composed of single fiber membrane tube or plural fiber membrane filaments. The hollow fiber membrane bundles(4) is steady affixed to the upper membrane lagging(17) and the lower membrane lagging(18) by sealing agent(14). Referring to FIG. 5 and FIG. 6, the fringe of the upper membrane lagging(17) conjugates with the inner wall of socket(15), and there is provided an O-type sealing ring(13) in the upper membrane lagging(17) which forms the disassembling structure of seal-connection with the socket(15) of the upper membrane tube cover(5).

Moreover, the present invention may have an alternative style, e.g. the upper membrane lagging(17) and the socket of the upper membrane tube cover(5) may be modified as follow. Referring to FIG. 7 and FIG. 8 and FIG. 14, the fringe of the upper membrane lagging(17) has outer screw thread(20), the corresponding socket(15) of the upper membrane tube cover(5) has conjugating inner screw thread. There is provided sealing ring(21) between bottom surface of the upper membrane lagging(17) and the upper membrane tube cover(5), to form the disassembling structure for seal-connection.

Moreover, the present invention may have another alternative style, e.g. the upper membrane lagging(17) and the socket of the upper membrane tube cover(5) may be modified as follow. Referring to FIG. 9 to FIG. 11 and FIG. 16, the fringe of the said upper membrane lagging(17) has protruding button(30), the corresponding socket(15) of the upper membrane tube cover(5) has conjugating L-type chute(31). There is provided sealing ring(32) between bottom surface of the upper membrane lagging(17) and the upper membrane tube cover(5), to form the disassembling structure for seal-connection. After the upper membrane lagging(17) is inserted, then it is rotated to make the protruding button(30) slide into the horizontal staple of the L-type chute(31); while taking it out, it is counter-rotated to make the protruding button(30) return back to vertical slide of the L-type chute(31), then the upper membrane lagging(17) is withdrawn.

At the time of use, raw water (wait to be filtered water) enters cartridge(3) from the water inlet(11) of lower cap(2). Under a certain pressure, the water permeates into the tube through the micro holes located in periphery of the wall of hollow fiber membrane bundle, then passes through flow way(9), from water outlet(12) of the upper cap(1) flows out (the flow out water is filtered water)). In need of cleaning hollow fiber membrane bundle(4), open the upper cap(1), from the cartridge(3) withdraw the upper membrane tube cover(5) as well as hollow fiber membrane bundle(4) and lower membrane tube cover(6) which is connected by a holder(8), then put them back to the cartridge(3) after rinsing. If 1 or 2 of hollow fiber membrane bundle(4) are found choked or other wrong condition, just withdraw the wrong hollow fiber membrane bundle from the upper membrane tube cover(5) and lower membrane tube cover(6) to replace. There is no need to replace whole. After using a period of time, open the sewage outlet(10) continuously or discontinuously to drain sewage (the water precluded by the micro hole of hollow fiber membrane bundle) that is staying at the space between the cartridge(3) and hollow fiber membrane bundle(4), from sewage outlet(10) to prevent blockage of the micro hole of hollow fiber membrane bundle and maintain the filtration quality. In the first embodiment mentioned above, various arrangement style of hollow fiber membrane bundle(4) in upper membrane tube cover(5) and lower membrane tube cover(6) may be referred to the illustration of FIG. 27 to FIG. 30.

### The Second Embodiment

Referring now to FIG. 17 to FIG. 19b, there is illustrating an alternative replaceable hollow fiber membrane filter device according to the present invention, comprising an upper cap(1), a lower cap(2), and a cartridge(3). The upper cap(1) and the lower cap(2) separately has a space which can accommodate upper membrane tube cover(5) and lower membrane tube cover(6). The cartridge has multiple hollow fiber membrane bundles(4) inside; and two ends of the hollow fiber membrane bundle(4) separately affix to the upper membrane tube cover(5) and the lower membrane tube cover(6). At the top of the cartridge has a casing(265) located outside; inside of the casing(265) there is upper annulus stair(254) and sewage outlet(10) connecting to inside of the cartridge(3). The top end of the cartridge(3) touches the upper annulus stair(254).

The lower membrane tube cover(6) has multiple fixing holes(250) used to accommodate the hollow fiber membrane bundle(4). The interval of each fixing hole(250) and the water inlet(11) of the lower cap(2) forms a water input way(252). The bottom side of the lower membrane tube cover(6) is located on lower annulus stair(257) which is under the space of lower cap(256). The upper membrane tube cover(5) is located in the space of upper cap(255), and connects to cartridge(3) and the upper cap(1) by a disassembling structure. Inside of the upper membrane tube cover(5) there is provided penetrating hole(262), and in the center there is provided fixing hole(251) used to connect and fix the holder(8); the other end of the holder(8) connects and fixes to fixing hole of lower membrane tube cover. The above-mentioned hollow fiber membrane bundle(4) is hollow fiber membrane filament (refer to FIG. 19a) or hollow fiber membrane tube (refer to FIG. 19b). The penetrating hole(262) of each upper membrane tube cover(5) and the fixing hole(250) of each lower membrane tube cover(6) has single or plural hollow fiber membrane filament or hollow fiber membrane tube, and seal-connected separately by sealing agent(14). The bottom side of hollow fiber membrane filament or hollow fiber membrane tube is sealed in he fixing hole(250) of the lower membrane tube cover(6), and the topside extends to outside of the penetrating hole(262) of the upper membrane tube cover(5) to form a flow way(9).

As illustrated in FIG. 18, the disassembling structure comprises an outgoing flange(253) located at the upper membrane tube cover(5), the flange(253) extends outward to the connecting place of the cartridge(3) and the upper cap(1), then is fixed between the flange(266) of the cartridge(3) and the flange(260) of the upper cap(1) by a fixing pinch(not shown in the drawing). There is provided an O-type sealing ring(261) between the flange(253) and the upper cap(1) and the casing(265).

Furthermore, the present invention may also have an alternative style. Referring now to FIG. 20 to FIG. 21b, there is illustrating modification of the connecting place of the upper membrane tube cover(5) and the cartridge(3), as well as the connecting place of the upper cap(1) and the lower cap(2). The inner side of the upper cap(1) has inner screw thread corresponding to outer screw thread which is located at outside of the casing(265) of the cartridge(3); inner screw thread and outer screw thread are connected by screwing. The fringe of the upper membrane tube cover(5) has outer screw thread(258) corresponding to inner screw thread which is located at inside of the casing(265) of the cartridge(3); inner screw thread and outer screw thread are connected by screwing. An O-type sealing ring(261) used to seal, is separately at the space between top surface and bottom surface of the upper membrane tube cover(5), and the upper cap(1), and the casing(265). The inner wall of the lower cap(2) has inner screw thread which is conjugated with the outer screw thread located on the outer wall of the cartridge(3); both are connected by screwing. A sealing ring is at the space between the bottom of the cartridge(3) and the lower cap(2). The above-mentioned hollow fiber membrane bundle(4) is hollow fiber membrane filament (refer to FIG. 21a) or hollow fiber membrane tube (refer to FIG. 21b).

Moreover, the present invention may also have an alternative. Referring now to FIG. 22 to FIG. 23b, there is illustrating modification of the connecting place of the upper membrane tube cover(5) and the cartridge(3), as well as the connecting place of the upper cap(1) and the lower cap(2). The inner side of the upper cap(1) has allocated protrusion corresponding to locking protrusion located at outside of the casing(265) of the cartridge(3); both are connected by locking. The fringe of the upper membrane tube cover(5) has locking protrusion(259) corresponding to allocated protrusion(263) located at inside of the casing(265) of the cartridge(3); both are connected by locking. An O-type sealing ring(261) used to seal, is separately at the space between top and bottom surface of the upper membrane tube cover(5), and the upper cap(1), and the casing(265). The inner wall of the lower cap(2) has allocated protrusion which is conjugated with the locking protrusion located on the outer wall of the cartridge(3); both are connected by locking. A sealing ring is at the space between the bottom of the cartridge(3) and the lower cap(2). The above-mentioned hollow fiber membrane bundle(4) is hollow fiber membrane filament (refer to FIG. 23a) or hollow fiber membrane tube (refer to FIG. 23b).

During the time of using, the raw water (the water wait to be filtered)) enters cartridge(3) homogenously from the water inlet(11) of lower cap(2) through the water input way(252) of lower membrane tube cover(6). Under a certain pressure, the water permeates into the tube through the micro holes located in periphery of the wall of hollow fiber membrane bundle(4), then passes through flow way(9), from water outlet(12) of the upper cap(1) flows out (the flow out water is filtered water). In need of cleaning or replacing hollow fiber membrane bundle(4), open the upper cap(1), from the cartridge(3) withdraw the upper membrane tube cover(5) as well as hollow fiber membrane bundle(4) and lower membrane tube cover(6) which is connected by a holder(8), then put them back to the cartridge(3) after rinsing or replacing. So the waste of replacing whole cartridge hull or the inconvenience of cleaning is avoidable. After using a period of time, open the sewage outlet(10) continuously or discontinuously to drain sewage (the water precluded by the micro hole of hollow fiber membrane bundle) that is staying at the space between the cartridge(3) and hollow fiber membrane bundle(4), from sewage outlet(10) to prevent blockage of the micro hole of hollow fiber membrane bundle and maintain the filtration quality. In the second embodiment mentioned above, the various arrangement of hollow fiber membrane bundle(4) in upper membrane tube cover(5) and lower membrane tube cover(6) may be referred to the illustration of FIG. 27 to FIG. 30.

### The Third Embodiment

Referring now to FIG. 24 to FIG. 26, there is illustrating an alternative replaceable hollow fiber membrane filter device according to the present invention. The structure in this embodiment basically is alike to the second embodiment, comprising an upper cap(1), a lower cap(2), and a cartridge(3). The cartridge(3) has multiple hollow fiber membrane bundles(4) inside; inside of the upper cap(1) and the lower cap(2) separately has a space which can accommodate upper membrane tube cover(5) and lower connecting tube. The upper membrane tube cover(5) has a pass-hole to accommodate the end of hollow fiber membrane bundles(4), and extends to outside of the upper membrane tube cover(5) to form a flow way(9). In the middle of the upper membrane tube cover(5) has a screwing hole(320) which is used to fix the top of the holder(8). Inside of the cartridge(3), the hollow fiber membrane bundles(4) are maintained in stretching condition by the supporting effect of the holder(8).

Lower connecting tube comprises a filament pressing disc(300) and a filament pressing rod(310). The filament pressing disc(300) has fixing hole(350) on it. The both end of the filament pressing rod(310) is bent downward to insert into the fixing hole(350), and fixed by screw nut(340). In the middle of the filament pressing rod(310) has screwing hole(330) used to fix the lower end of the holder(8) by screwing. The space of the lower cap(256) has lower annulus stair(257) inside; the fringe of the filament pressing disc(300) is located on the lower annulus stair(257). The hollow fiber membrane bundle(4) has two times of length, one end rounds on the filament pressing rod(310), and fixed in the pass-hole of the upper membrane tube cover(5) together with the other end.

The intention of the present invention is to provide a replaceable hollow fiber membrane filter device. Having illustrated and described the principles of my invention by what are presently preferred embodiments, it should be apparent to those persons skilled in the art that the illustrated embodiment may be modified without departing from such principles.

While a preferred embodiment of the device, together with alternate embodiments of the device, have been shown and described, it will be understood that there is no intent to limit the invention by its disclosure, but rather it is intended to cover all modifications and alternate constructions falling within the spirit and the scope of the invention as defined in the appended claims.

1. A replaceable hollow fiber membrane filter device, which comprises an upper cap, a lower cap, and a cartridge;
the cartridge has multiple hollow fiber membrane bundles inside; and upper membrane tube cover and lower membrane tube cover, both are used to fix two ends of hollow fiber membrane bundle; a holder is located between the upper membrane tube cover and the lower membrane tube cover;
the bottom of each hollow fiber membrane bundle has a lower membrane lagging, the top of each hollow fiber membrane bundle has an upper membrane lagging which extends outward to form a flow way; the aforementioned lower membrane tube cover has multiple slots which conjugate with the fringe of the lower membrane lagging; the upper membrane tube cover has sockets corresponding to each slot; upper membrane lagging penetrates the aforementioned socket, and seal-connects through a disassembling structure;
as a characteristic of replaceable hollow fiber membrane filter device.

2. A replaceable hollow fiber membrane filter device as defined in claim 1, wherein each aforementioned hollow fiber membrane bundle consists of single fiber membrane tube or plural fiber membrane filaments; the hollow fiber membrane bundle is fixed and connected to upper membrane lagging and lower membrane lagging by sealing agent.

3. A replaceable hollow fiber membrane filter device as defined in claim 1, wherein the fringe of aforementioned upper membrane lagging conjugates with inner wall of socket; an O-type sealing ring is inside the upper membrane lagging, to form a disassembling structure which seal-connects with socket of the upper membrane tube cover.

4. A replaceable hollow fiber membrane filter device as defined in claim 1, wherein the fringe of aforementioned upper membrane lagging has outer screw thread; the socket of corresponding upper membrane tube cover has inner screw thread for conjugation; a sealing ring is at the space between bottom surface of upper membrane lagging and upper membrane tube cover.

5. A replaceable hollow fiber membrane filter device as defined in claim 1, wherein the fringe of aforementioned upper membrane lagging has protruding button; the socket of corresponding upper membrane tube cover has L-type chute for conjugation; a sealing ring is at the space between bottom surface of upper membrane lagging and upper membrane tube cover.

6. A replaceable hollow fiber membrane filter device, which comprises an upper cap, a lower cap, and a cartridge;
the upper cap and the lower cap separately has a space for accommodating upper membrane tube cover and lower membrane tube cover;
the penetrating hole of the upper membrane tube cover and the fixing hole of the lower membrane tube cover has single or plural hollow fiber membrane filament(s), or single hollow fiber membrane tube, and is separately fixed and connected by sealing agent; the bottom end of hollow fiber membrane filament or hollow fiber membrane tube is sealed in the fixing hole of lower membrane tube cover; the top end extends outside of the penetrating hole of upper membrane tube cover to form flow way; the space between each fixing hole of the lower membrane tube cover and the water inlet of lower cap forms water input way for conducting;
as a characteristic of replaceable hollow fiber membrane filter device.

7. A replaceable hollow fiber membrane filter device as defined in claim 6, wherein the aforementioned lower membrane tube cover is fixed in the space of lower cap by a holder, the bottom is put on the lower annulus stair of the aforementioned space of lower cap; the upper membrane tube cover is put in the space of upper cap, and connects to cartridge and upper cap through a disassembling structure; the upper membrane tube cover has penetrating hole inside, in the middle has fixing hole which is used to fix and connect a holder; the other end of the holder is fixed and connected to the fixing hole of the lower membrane tube cover.

8. A replaceable hollow fiber membrane filter device as defined in claim 6, wherein outside of the top of the cartridge has a casing which has an upper annulus stair and a sewage outlet that interconnects the cartridge; the top end of the cartridge touches the upper annulus stair.

9. A replaceable hollow fiber membrane filter device as defined in claim 6, wherein the aforementioned upper membrane tube cover has flange which extends outward to the connecting place of the cartridge and the upper cap, and is fixed between the cartridge and the upper cap by fixing pinch; an O-type sealing ring is at the space between the flange and the upper cap and the casing.

10. A replaceable hollow fiber membrane filter device as defined in claim 6, wherein the inner side of the aforementioned upper cap has inner screw thread which corresponds to the outer screw thread located at outside of the casing of the cartridge, both are connected by screwing; the fringe of the upper membrane tube cover has outer screw thread which corresponds to the inner screw thread located at inside of the casing of the cartridge, both are connected by screwing; an O-type sealing ring is separately at the space between the top and bottom surfaces of upper membrane tube cover, and the upper cap, and the casing for sealing; the inner wall of lower cap has inner screw thread which connects to outer screw thread located at outer wall of the cartridge, by screwing; a sealing ring is at the space between the end of the cartridge and the lower cap.

11. A replaceable hollow fiber membrane filter device as defined in claim 6, wherein the inner side of the aforementioned upper cap has allocated protrusion which corresponds to the locking protrusion located at outside of the casing of the cartridge, both are connected by locking; the fringe of the upper membrane tube cover has locking protrusion which corresponds to the allocated protrusion located at inside of the casing of the cartridge, both are connected by locking; separately, an O-type sealing ring is at the space between the top and bottom surfaces of upper membrane tube cover, and the upper cap, and the casing for sealing; the inner wall of lower cap has allocated protrusion which connects to locking protrusion located at outer wall of the cartridge, by locking; a sealing ring is at the space between the end of the cartridge and the lower cap.

12. A replaceable hollow fiber membrane filter device mainly consists of upper cap, lower cap, and cartridge; the cartridge has multiple hollow fiber membrane bundles inside;
a space for accommodating upper membrane tube cover and a space for accommodating lower connecting tube separately located in upper cap and lower cap; upper membrane tube cover has pass-hole for accommodating the end of hollow fiber membrane bundle, and extends to outside of the upper membrane tube cover to form flow way; in the middle of the upper membrane tube cover has screwing hole for fixing the top of a holder; by the supporting effect of the holder, the hollow fiber membrane bundle maintains stretching state in the cartridge.
as a characteristic of replaceable hollow fiber membrane filter device.

13. A replaceable hollow fiber membrane filter device as defined in claim 12, wherein the aforementioned lower connecting tube comprises a filament pressing disc and a filament pressing rod; the filament pressing disc has fixing hole on it; the both end of the filament pressing rod are bent downward to insert into the fixing hole, and fixed by screw nut; in the middle of the filament pressing rod has screwing hole used to fix the lower end of the holder by screwing; the space of the lower cap has lower annulus stair inside; the fringe of the filament pressing disc is located on the lower annulus stair; the hollow fiber membrane bundle has two times of length, one end rounds on the filament pressing rod, and fixed in the pass-hole of the upper membrane tube cover together with the other end.
